(19) United States
(12) Patent Application Publication
(10) Pub. No.: US 2026/0228490 A1
(43) Pub. Date: Aug. 6, 2026

(54) NEURAL NETWORKS WITH INTENTION LAYERS

(71) Applicant: GDM Holding LLC, Mountain View, CA (US)

(72) Inventor: Marta Garnelo Abellanas, London (GB)

(21) Appl. No.: 19/151,227

(22) PCT Filed: Jan. 26, 2024
(86) PCT No.: PCT/EP2024/051943

§ 371 Date: Jul. 25, 2025

Related U.S. Application Data
(60) Provisional application No. 63/441,442, filed on Jan. 26, 2023.

(51) Int. Cl. G06N 3/045; G06N 3/0499

(52) U.S. Cl. CPC G06N 3/045; G06N 3/0499

(57) ABSTRACT

Systems and methods for processing inputs using neural networks with intention layers. Each intention layer includes one or more intention sub-layers that are each configured to: obtain a query matrix, a key matrix, and a value matrix for the intention sub-layer, wherein at least one of the query matrix, the key matrix, and the value matrix are derived from the layer input to the intention layer; determine a key covariance matrix that estimates a covariance of the key matrix; determine an inverse matrix that represents an inverse of the key covariance matrix; and determine a sub-layer output for the intention sub-layer from the inverse matrix, the query matrix, and the value matrix.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs a machine learning task on a network input.

The machine learning task can be any machine learning task that (i) operates on a network input that is an input sequence, (ii) generates a network output that is an output sequence, or (iii) both.

In particular, the system performs the task using a neural network that includes one or more intention layers.

An intention layer is layer that includes one or more intention sub-layers that each operate on keys, values, and queries.

Particular embodiments of the subject matter described in this specification can be implemented so as to realize one or more of the following advantages.

Attention-based models have been a key element of many recent breakthroughs in deep learning. Two key components of attention are the structure of its input (keys, values and queries) and the computations by which these inputs are combined. This specification describes an intention layer, which shares input structure with attention but is not restricted to the computations of attention. That is, the operations performed by an intention layer are also in Keys-Values-Queries (KVQ) Space, but cannot efficiently be approximated by attention. Thus, intention layers can represent or approximate function that cannot be represented or approximated by attention (or a stack of multiple attention layers) but that are useful for performing real-world machine learning tasks. For example, unlike attention, intention layers can efficiently approximate the solution to the standard least squares problem, i.e., the solution to regularized least squares. Regularized least squares are one of the most widely used methods in data science, e.g., to predict future elements of a time series. As another example, intention layers can represent other canonical machine learning problems such as linear discriminant analysis (LDA) and least-squares support vector machines (LS-SVMs). Thus, by including intention layers within a neural network, e.g., instead of or in addition to attention layers, the performance of the neural network on any of a variety of tasks can be improved, e.g., because the resulting neural network can learn to approximate functions that are useful for the task that could not have been approximated efficiently by a neural network that has only attention layers.

Additionally, the computational complexity of an intention layer is the same as that of attention. Thus, the neural network can achieve this improved performance without a corresponding decrease in computational efficiency.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example architecture of an informer neural network.

FIG. 3 shows two variants of intention sub-layers.

FIG. 4 is a flow diagram of an example process for processing initial query, key and value matrices.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task using a neural network that includes one or more intention layers.

The machine learning task can be any machine learning task that (i) operates on a network input that is an input sequence, (ii) generates a network output that is an output sequence, or (iii) both.

Some examples of machine learning tasks that the system can be configured to perform are described below.

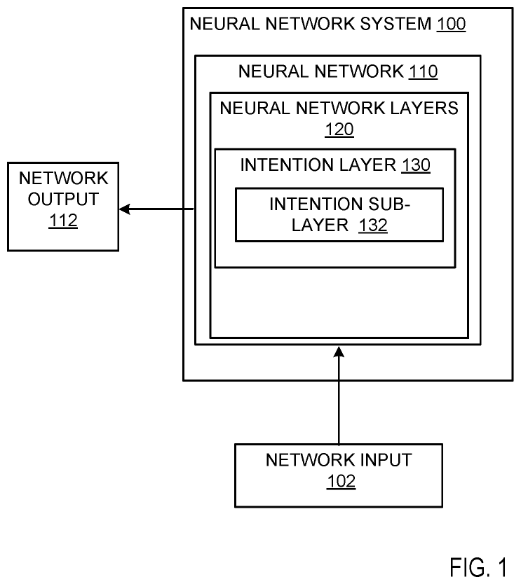

FIG. 1 shows an example neural network system 100. The neural network system 100 is an example of a system implemented as computer programs on one or more computers in one or more locations, in which the systems, components, and techniques described below can be implemented.

The system 100 processes a network input 102 using an informer neural network 110 that includes one or more intention layers 130 to generate a network output 122 as part of performing the task.

More specifically, the neural network 110 has a plurality of layers 120 that include one or more intention layers 130.

Each intention layer 130 includes a set of one or more intention sub-layers 132.

Each intention sub-layer 132 is configured to perform operations on a query matrix, a key matrix, and a value matrix for the intention sub-layer 132. For example, the sub-layer 132 can perform operations to extract information from a collection of key-value pairs and apply it to a set of query points.

Generally at least one of the query matrix, the key matrix, and the value matrix are derived from the layer input to the intention layer 130. For example, all of the query matrix, the key matrix, and the value matrix can be derived from the layer input to the intention layer 130. As another example, the query matrix can be derived from the layer input to the intention layer 130 while the key matrix and the value matrix are derived from a memory associated with the intention layer 130, e.g., from encoded representations of the network input 102 generated by an encoder neural network or some other context for generating the network output 112.

In some cases, the queries, keys, and values for sub-layers 132 in different intention layers 130 can be derived differently for different intention layers 130.

The layers 120 in the neural network 110 can include other types of layers in addition to the intention layers 130. For example, the neural network 110 can include one or more input layers, e.g., embedding layers, before the first intention layer 130 and one or more output layers after the last intention layer 130.

The neural network 110 can also include other types of layers interspersed among the intention layers, e.g., feed-forward layers, e.g., fully-connected layers, attention layers, convolutional layers, and so on.

In some cases, the neural network 110 is arranged in an encoder-decoder architecture, and some intention layers 130 are in the encoder while others are in the decoder. In other cases, the neural network 110 can include only an encoder or only a decoder.

In some implementations the system can be used to generate, from the input sequence, a network output that comprises an output sequence.

For example the input sequence and output sequence may each comprise a sequence of tokens.

For example in some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g. for question answering, or for text completion. In some implementations the input sequence may represent text in a natural language and the output sequence may represent text in the same natural language, e.g. a longer item of text. For example in some implementations the input sequence may represent text in a natural language and the output sequence may represent the same text with a missing portion of the text added or filled in. For example the output sequence may represent a predicted completion of text represented by the input sequence. Such an application may be used, e.g. to provide an auto-completion function e.g. for natural language-based search. In some implementations the input sequence may represent a text in a natural language e.g. posing a question or defining a topic, and the output sequence may represent a text in a natural language which is a response to the question or about the specified topic.

As another example the input sequence may represent a first item of text and the output sequence may represent a second, shorter item of text e.g. the second item of text may be a summary of a passage that is the first item of text. As another example the input sequence may represent a first item of text and the output sequence may represent a simplification of the first item of text. As another example the input sequence may represent a first item of text and the output sequence may represent an aspect of the first item of text e.g. it may represent an entailment task, a paraphrase task, a textual similarity task, a sentiment analysis task, a sentence completion task, a grammaticality task, a parsing task, e.g., constituency parsing, and in general any natural language understanding task that operates on a sequence of text in some natural language e.g. to generate an output that classifies or predicts some property of the text. For example some implementations may be used to identify a natural language of the first item of text, or of spoken words where the input is audio (as described below).

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

Some implementations may be used for speech recognition. In such applications the input sequence may represent spoken words and the output sequence may represent a conversion of the spoken words to a machine-written representation e.g. text. Then the input tokens may comprise tokens representing an audio data input including the spoken words e.g. characterizing a waveform of the audio in the time domain or in the time-frequency domain. The output tokens may represent words, wordpieces, characters, or graphemes of a machine-written, e.g. text, representation of the spoken input, that is representing a transcription of the spoken input.

Some implementations may be used for handwriting recognition. In such applications the input sequence may represent handwritten words, syllabograms or characters and the output sequence may represent a conversion of the input sequence to a machine-written representation e.g. text. Then the input tokens may comprise tokens representing portions of the handwriting and the output tokens may represent words, wordpieces, characters or graphemes of a machine-written, e.g. text, representation of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g. tokens characterizing a portion of a waveform of the speech in the time domain or in the time-frequency domain, or phonemes.

In some implementations the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (RoIs) in the image, optionally including one or more tokens for global image features. For example an image may be encoded using a neural network to extract RoI features; optionally (but not essentially) a token may also include data, e.g. a position encoding, representing a position of the RoI in the image. As another example, the tokens may encode color or intensity values for pixels of an image. As another example, some image processing neural network systems e.g. autoregressive systems, naturally represent images as sequences of image features.

As another example, the neural network system may be used to process images instead of or as well as text (e.g. if trained on images instead of or as well as text).

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video e.g. described by the text, or providing a visual answer to a question posed by the text, or providing a visualization of a topic of the text. In another example the input sequence may comprise a sequence of input tokens representing an image or video, and the output tokens may represent words or wordpieces, or characters representing text e.g. for a description or characterization of the image or video, or providing an answer to a question posed visually by the image or video, or providing information on a topic of a topic of the image or video.

In some other implementations both the input sequence and the output sequence may represent an image or video, and both the input tokens and the output tokens may represent a respective image or video. In such implementations the method/system may be configured (trained) to perform an image or video transformation. For example the input sequence and the output sequence may represent the same image or video in different styles e.g. one as an image the other as a sketch of the image; or different styles for the same item of clothing.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network. For example, a neural network comprising one or more intention layers can be arranged as in encoder-decoder architecture and trained to compress and decompress any form of data, and then the trained encoder and decoder can be used separately to compress, and decompress the data.

In some implementations the input sequence represents a sequence of actions to be performed by an agent e.g. a mechanical agent in a real-world environment implementing the actions to perform a mechanical task. The output sequence may comprise a modified sequence of actions e.g. one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence may comprise a sequence of predicted treatment. Then the input tokens may represent any aspect of the health of a patient e.g. data from blood and other medical tests on the patient and/or other patient data; and the output tokens may represent diagnostic information e.g. relating to a disease status of the patient and/or relating to suggested treatments for the patient, and/or relating to a likelihood of an adverse health event for the patient.

In some implementations the input sequence represents a time series and the output sequence may comprise a continuation of the time series. For example the input sequence may be a sequence representing the output of (or input to) an electricity generating plant, e.g. a solar or wind electricity generating plant, or a sequence representing electricity consumption, and the output sequence may provide a forecast of the electricity generated or consumed. The forecast may then be used to control the electricity generating plant, e.g. to control how energy is harvested from the solar or wind input, and/or how power is delivered to the grid or stored, or for apportioning the delivery of power to multiple power consuming entities. As another example the input sequence may be a sequence representing a level of traffic on one or more roads and the output sequence may provide a forecast of the future traffic.

In some implementations, each network input in the input sequence may comprise a data element embedding. As used herein an embedding refers to an ordered collection of numerical values, e.g., a vector, matrix, or other tensor of numerical values.

For example the data element embeddings may represent the pixels of an image or video and the network output may comprise a classification output, e.g. that includes a respective score for each object or action category in a set of possible object or action categories, defining a likelihood that the image depicts an object or action that belongs to the object or action category.

In some implementations the data element embeddings represent audio samples in an audio waveform and the system is configured (trained) to perform speech recognition, i.e., to generate a network output that defines a sequence of phonemes, graphemes, characters, or words corresponding to the audio waveform.

In some implementations, the data element embeddings represent words in a sequence of words and the system is configured to perform a natural language processing task, e.g., topic classification or summarization. To perform topic classification, the network output can include a respective score for each topic category in a set of possible category categories, e.g. the score for a topic category can define a likelihood that the sequence of words pertains to the topic category.

In some implementations, the system/method is configured (trained) to perform an audio processing task. For example, if the data element embeddings represent a spoken utterance, then the network output may be a score for each of a set of pieces of text, each score representing an estimated likelihood that the piece of text is the correct transcript for the utterance. As another example, if the data element embeddings represent a spoken utterance, the network output can indicate whether a particular word or phrase (“hotword”) was spoken in the utterance. As another example, if the data element embeddings represent a spoken utterance, the network output can identify the natural language in which the utterance was spoken.

In some implementations, the system/method can perform an image generation task, where the data element embeddings represent a conditioning input, e.g. text, and the network output defines a sequence of intensity value inputs for the pixels of an image. The conditioning input can define one or more characteristics of the image, e.g. it may comprise a label for a type of image to be generated, or it may comprise a conditioning image or part of a conditioning image and the image generation task may be to generate another similar image, or another version of the image, e.g. a colorized version or a version that is infilled or extrapolated from the conditioning image.

In some implementations, as described further below, the system/method can perform an agent control task, where the data element embeddings represent a sequence of one or more observations and/or other data characterizing states of an environment, e.g. a real-world environment, e.g. from one or more sensors, and the network output comprises a policy output for selecting an action to be performed by the agent. The agent can be, e.g., a real-world or simulated mechanical agent (such as a robot or vehicle), a control system for an industrial facility, or a control system that controls a different kind of agent.

In some implementations, the system/method can perform a point cloud processing task, e.g., where the data element embeddings represent a point cloud (e.g., generated by a lidar or radar sensor) and the network output characterizes, e.g., a type of object represented by the point cloud.

In some implementations, the system/method is configured to perform a combination of multiple individual machine learning tasks, e.g., two or more of the machine learning tasks mentioned above.

The system/method neural network can process data element embeddings that represent any appropriate type of entity. For example, the entity can include an image, an audio waveform, a point cloud (e.g., generated by a lidar or radar sensor), a protein (e.g. defined by an amino acid sequence), a sequence of words (e.g., that form one or more sentences or paragraphs), a video (e.g., represented a sequence of video frames), or a combination thereof, e.g. multimodal data. In general the entity can be obtained from a sensor sensing a real-world environment. The network output can characterize the entity (e.g. classifying the entity by defining a score for each category of a set of possible categories), or can perform a processing task on the entity.

Implementations of the system/method can process multimodal data of a multimodal entity. Such an entity can include may comprise a combination of different types of data, such as image or video data and audio data, image or video data and language data, somatosensory input data (sensor data sensing the real-world environment of a physical agent, such as sensing touch, pressure, movement, temperature or vibration data) and motor feedback data (i.e. control data to control movement of the physical agent). When a multimodal entity is processed by the system/method embeddings of the data elements of the different modalities may be combined.

The network output for the multimodal entity may be as previously described. For example where the network output is a classification output for a classification task (e.g. defining a score for each category of a set of possible categories), this may be as previously described except that the network output is generated based upon the multimodal data embeddings provided as the input. Thus the machine learning task, e.g. classification, performed by the system may be performed better, e.g. more accurately, as a result. For example a classification task may be performed on a combination of video and (corresponding) audio data to obtain a more accurate classification result. As another example the machine learning task may be one that is based upon processing data of different modalities, e.g. in a task that combines video or image data and language data e.g. text data, to determine whether an image or video is described by a particular caption. As a further example, the network output may define the result of a task obtained by processing a multimodal input comprising an image or video and text or audio that requests the task to be performed based on the image or video input, e.g. the answer to a text or audio question or a request for an OCR (optical character recognition) or other image processing task to be performed.

As described above, the layers 120 within the neural network 110 can be arranged in a variety of configurations.

As one example, when the network input 102 is an input sequence, the informer neural network 110 can process the network input 102 in a single forward pass to generate the network output 112.

As another example, when the network input 102 is an input sequence or has been mapped to an input sequence by an encoder neural network and the network output 112 is also a sequence that includes multiple elements, the informer neural network 110 can operate auto-regressively and generate the network output 112 over multiple time steps. At each time step, the informer neural network 110 processes the network input 102 (or a sequence generated from the network input 102) and the already generated elements of the output sequence to generate the next one or more elements of the output sequence.

As yet another example, when the network input 102 is an input sequence and the network output 112 is also a sequence that includes multiple elements, the informer neural network 110 can include an encoder neural network that generates a respective encoded representation of each of the inputs in the input sequence in a single forward pass and a decoder neural network that operates auto-regressively and generates the network output 112 over multiple time steps. At each time step, the decoder neural network processes the encoded representations and the already generated elements of the output sequence to generate the next one or more elements of the output sequence. In these examples, some of the intention layers 130 are in the encoder neural network while others are in the decoder neural network.

Each intention layer 130 operates on a respective layer input that includes a respective input vector at each of one or more positions.

As described above, the queries, keys, and values for any given intention sub-layer 132 depend on the configuration of the informer neural network.

As one example, as described above, when the network input 102 is an input sequence, the informer neural network 110 can process the network input 102 in a single forward pass to generate the network output 112. In this example, the intention layers use the layer input to generate the query, keys, and value matrices for the sub-layers.

As another example, as described above, when the network input 102 is an input sequence or has been mapped to an input sequence by an encoder neural network and the network output 112 is also a sequence that includes multiple elements, the informer neural network 110 can operate auto-regressively and generate the network output 112 over multiple time steps. At each time step, the informer neural network 110 processes the network input 102 (or the sequence generated from the network input) and the already generated elements of the output sequence to generate the next one or more elements of the output sequence. In this example, the intention sub-layers apply causal self-“intention,” where the intention layers use the layer input to generate the query, keys, and value matrices for the sub-layers, but implement a causal masking. Here causal masking refers to, e.g., masking values so that at each time step an intention sub-layer sees only past inputs in a sequence of processed inputs.

As another example, when the network input 102 is an input sequence and some of the intention layers are in the encoder portion of the informer neural network 110 and other layers are in the decoder portion of the informer neural network 110, the informer neural network 110 can process the network input 102 using the encoder portion in a single forward pass to generate an encoded representation of the input. In this example, the intention sub-layers within the encoder portion apply non-causal self-“intention”. The decoder portion of the informer neural network 110 can then operate auto-regressively and generate the network output 112 over multiple time steps. At each time step, the informer neural network 110 processes the already generated elements of the output sequence to generate the next one or more elements of the output sequence conditioned on the encoded representation. In this example, some of the intention sub-layers in the decoder apply causal self-“intention” while others of the intention sub-layers in the decoder apply cross-“intention” between the already generated elements of the output sequence and the encoded representation.

As described above, each intention layer 130 includes one or more intention sub-layers 132. That is, when the layer 130 includes multiple intention sub-layers, the layer 130 operates as a multi-head intention layer and, when the layer 130 includes a single sub-layer, the layer 132 operates as a single-head intention layer.

When there are multiple intention sub-layers 132 within the intention layer 130, the intention layer 130 then generates a final layer output by combining the outputs generated by the sub-layers, e.g., by concatenating the sub-layer outputs and, optionally, applying a learned transformation, e.g., a linear transformation, to the concatenation.

As used in this specification, the term “learned” means that an operation or a value has been adjusted during the training of the informer neural network.

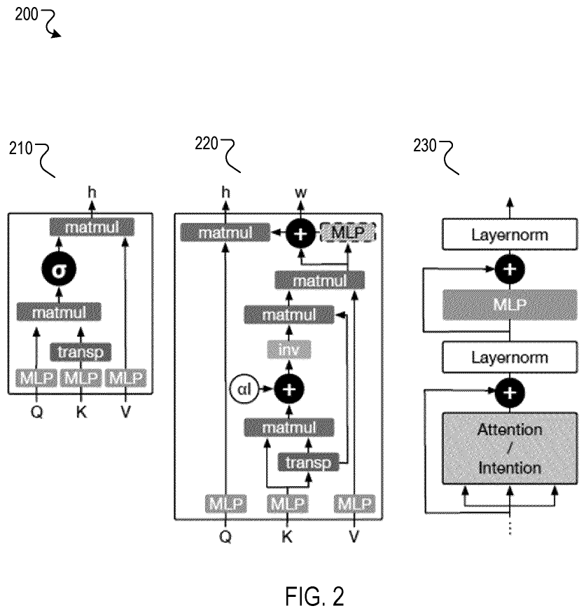

FIG. 2 shows an example 200 of the architecture of an attention sub-layer 210, an intention sub-layer 220, and of a layer block 230 of the neural network 110.

In the example of FIG. 2, the layer block 230 includes an attention or an intention layer (which, in turn, includes one or more attention sub-layers 210 or one or more intention sub-layers 220), followed by a residual connection. The residual connection is followed by a layer normalization (“layernorm”) operation (Be et al., arXiv: 1607.06450), which is followed by a multi-layer perceptron (MLP) that is applied position-wise, another residual connection and then another layernorm operation. The neural network 110 can include multiple layer blocks 230. While not shown, the neural network 110 can also include other components, e.g., an input embedding layer that embeds the inputs to the neural network 110, an output subnetwork that processes the output of the last layer block 230 to generate the network output (or, more generally, one or more elements of the network output), and so on. Thus, in this example, the first layer block 230 in the neural network receives the output of the embedding layer and the output of the last layer block 230 is provided as input to the output subnetwork, which can have any appropriate architecture and generates one or more elements of the network output.

Thus, as can be seen from FIG. 2, an intention layer can be a “drop-in” replacement for any attention layer in any layer block of any Transformer neural network, e.g., an encoder-only Transformer neural network, an encoder-decoder Transformer neural network, a decoder-only Transformer neural network, or any other appropriate neural network architecture that includes one or more layer blocks that each include attention layers. Thus, for example, the described intention layers can be used in any Transformer-based neural network system described in the literature, for a corresponding purpose, and trained using the same training data. Intention layers can be used as well as or instead of attention layers.

As shown in FIG. 2, both the attention sub-layer 210 and the intention sub-layer 220 operate in QKV space, i.e., receive as input an initial matrix of queries Q, an initial matrix of keys K, and an initial matrix of values V and perform operations, e.g., matrix multiplication (“matmul”), on the matrices Q, K, and V to generate an output “h.”

The initial matrix of queries Q includes a set of vectors (“queries” or “query vectors”) arranged as rows or columns of the matrix.

The initial matrix of keys K includes a set of vectors (“keys” or “key vectors”) arranged as rows or columns of the matrix.

The initial matrix of values V includes a set of vectors (“values” or “value vectors”) arranged as rows or columns of the matrix.

Depending on the configuration of the neural network 110, the vectors in the initial matrices can be from different sources. Generally, the query vectors are the vectors in the layer input to the attention or intention layer, respectively. In some cases, key and value vectors are also the vectors in the layer input to the attention or intention layer while in other cases the key and value vectors are memory vectors, e.g., encoded representations of the network input or other memory vectors that provide context for the generation of the network output.

However, the operations performed by the sub-layers 210 and 220 are different.

The attention sub-layer 210 applies respective transformations, e.g., respective single projection matrices or respective multi-layer perceptrons (MLPs) as shown in the Figure, to Q, K and V, to generate matrices of queries, keys, and values. The attention sub-layer 210 then performs a transpose of the output of the key matrix to generate a transposed matrix K′ and performs a matmul between the output of the query matrix and K′ to generate an initial attention weight matrix. The attention sub-layer then applies a row-wise softmax σ to the initial attention weight matrix to generate an attention weight matrix and performs a matmul between the attention weight matrix and the value matrix to generate the sub-layer output for the attention layer (h). While not shown, the sub-layer 210 can also perform other operations as part of generating h, e.g., by scaling the initial attention weight matrix by a scaling factor before applying σ.

The intention sub-layer 220, however, performs a different set of operations on Q, K, and V that cannot be approximated by the attention sub-layer 210.

At a high-level, the intention sub-layer 220 determines a key covariance matrix that estimates a covariance of the key matrix and then determines an inverse matrix that represents an inverse of the key covariance matrix. The intention sub-layer 220 then determines the sub-layer output for the intention sub-layer (that includes h) from the inverse matrix, the query matrix, and the value matrix. It is this approach that allows an intention layer to represent functions that conventional attention layers cannot efficiently approximate, such as a regularized least squares problem. There are various different ways of incorporating determination of a key covariance matrix and its inverse into an intention sub-layer; some examples are described below.

As one particular example, and as shown in FIG. 2, an intention sub-layer hint is a neural network module that applies a set of operations of the following form to an input initial query, key, and value matrices Q, K and V:

$$Q {{θ}_{1} [ {( K {θ}_{2} )}^{′} K {θ}_{2} + α I ]}^{- 1} {( K {θ}_{2} )}^{′} V {θ}_{3} ,$$

where θ₁, θ₂, θ₃ are respective parameter matrices of the intention layer and a is a covariance smoothing parameter that is greater than or equal to zero. Here a parameter matrix is a matrix of learnable parameter values of the intention sub-layer, and “′” denotes a matrix transpose operation.

Thus, in this expression, (Kθ₂)′Kθ₂+αI represents the key covariance matrix and [(Kθ₂)′Kθ₂+αI]⁻¹ represents the inverse of the key covariance matrix.

While, for simplicity, the above expression indicates that the query, key, and value matrices are generated by applying a respective parameter matrix θ₁, θ₂, θ₃ to the initial query, key, and value matrices. More generally and as shown in FIG. 2, the intention sub-layer can generate the query, key, and value matrices by applying any appropriate multi-layer perceptron (MLP) based embedding function to the initial query, key, and value matrices. That is, the parameter matrices can be replaced by MLPs (with layer sizes appropriate to the input and output dimensions), that can incorporate a non-linearity, e.g. ReLU. In other words, the query, key, and value matrices can be generated using either (i) a respective linear projection with a respective parameter matrix or (ii) using a respective MLP.

As reflected in the above example expression, in some implementations the intention layer determines, from the inverse matrix and the value matrix, a mapping matrix w and then determines the sub-layer output from the mapping matrix and the query matrix. In this expression above and as shown in FIG. 2, the intention layer determines the mapping matrix by computing a first matrix product between the inverse matrix and a transpose of the key matrix, i.e., by computing [(Kθ₂)′Kθ₂+αI]⁻¹(Kθ₂)′, and then computing a second matrix product between the first matrix product and the value matrix, i.e., by computing [(Kθ₂)′Kθ₂+αI]⁻¹(Kθ₂)′ Vθ₃.

A more general description of the mapping matrix w is given below. For example the mapping matrix w can be determined as a product of the inverse of the key covariance matrix, an embedding (a transposed embedding) of the key matrix, and an embedding of the value matrix. The sub-layer output can then be determined from a product of an embedding of the query matrix and the mapping matrix w.

In some implementations, e.g., when the intention layer is the only intention layer in the neural network, the intention sub-layer can also provide the mapping matrix as part of the sub-layer output of the intention sub-layer.

The intention layer can also perform other, optional, operations.

For example, as shown in FIG. 2, the intention layer can compute an initial mapping matrix as described above, and then process the initial mapping matrix using a single linear layer or a multi-layer perceptron (MLP) to generate an updated mapping matrix, and then compute the final mapping matrix w as a sum of the initial mapping matrix and the updated mapping matrix.

Put another way, the set of operations performed by an intention sub-layer can be represented as:

$${h}_{i n t} ( K , V , Q ) = {E}_{Q} w ( K , V ) ,$$

$${E}_{Q} = {e}_{Q} ( Q ) ,$$

$$w ( K , V ) = {e}_{w} [ \sum {( {E}_{Q} )}^{- 1} {E}_{K}^{′} {E}_{V} ]$$

$${E}_{K} = {e}_{K} ( K )$$

$${E}_{V} = {e}_{V} ( V )$$

where w(K, V) yields the mapping matrix, e is any appropriate MLP-based embedding function (or a linear embedding defined by a parameter matrix can be used as described above), and Σ is a function that performs covariance estimation, e.g., (E_{K})′E_{K}+αI as described above. Thus, in this formulation Σ(E_{Q}) is the key covariance matrix.

In some implementations, the system can increase the computational efficiency of the operations performed by the intention sub-layer. For example, the system can apply an additional mapping φ(X)=XK′(KK′)^{-1/2} to both E_{Q} and E_{R}. Making use of this additional mapping allows the system to incorporate a kernel function K and obtain:

$${ϕ}_{K} ( X ) = K ( X , K ) {K ( K , K )}^{- 1 / 2} ,$$

which allows the system to reduce the computational complexity of the operation of the sub-layer by employing kernel approximation, e.g., the Nystroem method of kernel approximation.

In some implementations, the system can incorporate a scaling factor into one or more of the operations performed by the intention sub-layer, e.g., to ensure the variance at initialization is close to 1 and assist with stable training. That is, the intention layer can optionally apply a scaling factor, i.e., by dividing each element of one of the matrices operated on by the intention layer by the scaling factor. For example, the system can divide the mapping matrix or any other intermediate matrix produced by the sub-layer by the scaling factor.

In some implementations, the system determines the inverse matrix by computing an inverse of the key covariance matrix. However, in practice, the key covariance matrix may not always be an invertible matrix. To account for this, the system can determine the inverse matrix as a pseudo-inverse of the key covariance matrix, e.g., the Moore-Penrose pseudoinverse.

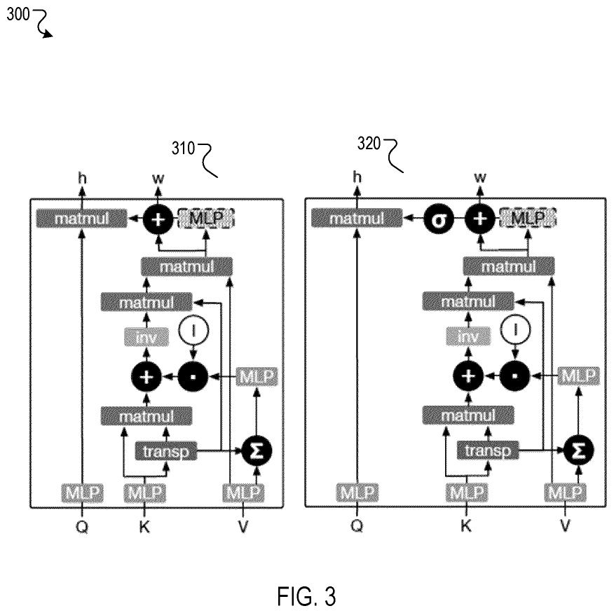

Other examples of operations performed by an intention sub-layer are described below with reference to FIG. 3.

FIG. 3 shows two variants of an intention sub-layer, a first variant 310 and a second variant 320.

In the first variant 310, the intention sub-layer uses a covariance smoothing parameter α that is learned rather than fixed or discovered using a hyperparameter search. In particular, as shown in FIG. 3, the system determines α using the transpose of the key matrix, e.g., (E_{K})′, and the value matrix, e.g., E_{V}. More specifically, the system determines Σ((E_{K})′, E_{V}) and then uses Σ((E_{K})′, E_{V}) to determine α by processing Σ((E_{K})′, E_{V}) using an MLP-based transformation. Σ((E_{K})′, E_{V}) can be any appropriate operation that, e.g., measures the covariance of the two input matrices to the operation.

In the second variant 320, in addition to using a learned smoothing parameter α, the intention sub-layer also applies a row-wise softmax σ to the mapping matrix w before computing a matmul between the w and the query matrix in order to generate h. Whilst illustrated in the context of FIG. 3, in general a softmax operation may be applied to the mapping matrix in any of the implementations described herein.

When there are multiple sub-layers 220 within a given intention layer, the intention layer 130 then combines the sub-layer outputs generated by the multiple sub-layers 220 by concatenating (“concat”) the sub-layer outputs to generate a concatenated sub-layer output and then applying a linear transformation to the sub-layer output to generate the final layer output.

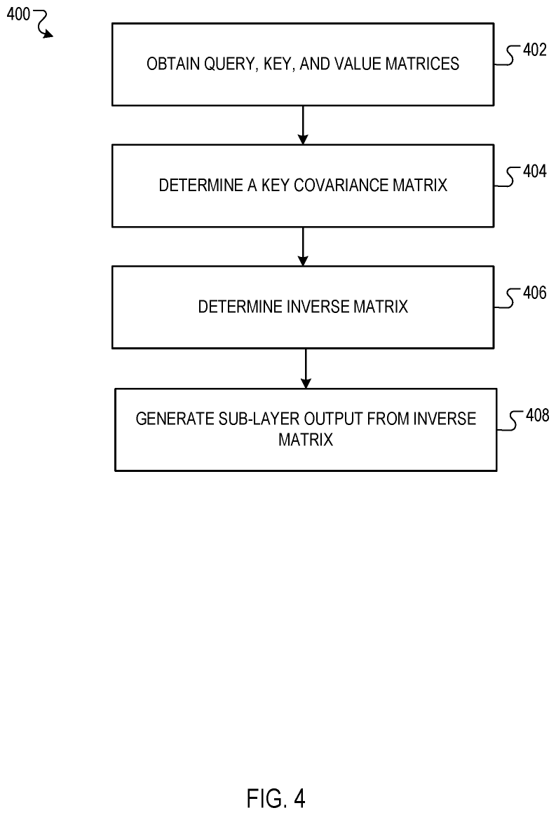

FIG. 4 is a flow diagram of an example process 400 for processing an initial query, key, and value matrices using an intention layer. For convenience, the process 400 will be described as being performed by a system of one or more computers located in one or more locations. For example, a neural network system, e.g., neural network system 100 of FIG. 1, appropriately programmed in accordance with this specification, can perform the process 400.

The process 400 can be performed by each sub-layer of an intentional layer to generate a respective sub-layer output for the sub-layer.

The system obtains a query matrix, a key matrix, and a value matrix for the intention sub-layer (step 402).

Generally, the system obtains an initial query matrix, an initial key matrix, and an initial value matrix. The system then applies respective sets of learned transformations to the initial matrices to generate the query, key, and value matrices.

Specifically, during processing, the intention layer receives a layer input. Generally, the layer input is a sequence of vectors, i.e., a sequence of ordered collections of numerical values.

The system then generates at least one of the query matrix, key matrix, or value matrix from the layer input.

For example, when the intention layer is applying self-intention, the system generates the initial query, key and value matrices from the layer input.

When the intention layer is applying cross-intention between the layer input and a memory, the system generates the initial query matrix from the layer input and generates the initial key and value matrices from the memory.

The system determines a key covariance matrix that estimates a covariance of the key matrix (step 404). For example, as described above, the system can compute the key covariance matrix (E_{K})′Eₖ+αI as described above. Thus, the system computes a matrix product between a transpose of the key matrix and the key matrix and then sums the matrix product with a product between a scalar value and an identity matrix.

The system determines an inverse matrix that represents an inverse of the key covariance matrix (step 406). As described above, the inverse matrix can be either the inverse or the pseudo-inverse of the key covariance matrix.

The system then determines a sub-layer output for the intention sub-layer from the inverse matrix, the query matrix, and the value matrix (step 408).

For example, the system can determine a mapping matrix from the inverse matrix and the value matrix and then determine the sub-layer output from the mapping matrix and the query matrix.

To compute the mapping matrix, the system can compute a first matrix product between the inverse matrix and a transpose of the key matrix and then compute a second matrix product between the first matrix product and the value matrix to generate an initial mapping matrix.

In some implementations, the system uses the initial mapping matrix as the mapping matrix. In some other implementations, the system applies one or more learned transformations to the second matrix product to generate an updated mapping matrix. The system can then, e.g., use the updated mapping matrix as the mapping matrix or sum the initial and updated mapping matrices to generate the mapping matrix.

To determine the layer output from the mapping matrix and the query matrix, the system can determine a third matrix product between the query matrix and the mapping matrix. Optionally, prior to determining the third matrix product, the system can apply a row-wise softmax function the mapping matrix.

During the processing of a given network input, for each intention layer in the informer neural network, the system can perform the process 400 to update the layer input to the layer. By repeatedly performing this processing for all of the intention layers in the informer neural network and then by processing at least part of the layer output generated by the last intention layer in the informer neural network using one or more output layers, e.g., one or more linear layers optionally followed by a softmax layer or, more generally, a multi-layer perceptron (MLP), the system can generate a network output for a received network input.

That is, the process 400 can be performed as part of predicting an output for an input for which the desired output, i.e., the output that should be generated by the system for the input sequence, is not known.

The process 400 can also be performed as part of processing inputs derived from a set of training data, i.e., inputs derived from a set of inputs for which the output that should be generated by the system is known, in order to train the informer neural network to determine trained values for the parameters of the informer neural network.

The system can repeatedly perform the process 400 on inputs selected from a set of training data as part of a conventional machine learning training technique to train the intention layers and the output layer(s) of the neural network, e.g., a gradient descent with backpropagation training technique that uses a conventional optimizer, e.g., stochastic gradient descent, RMSprop, or Adam optimizer, to optimize an objective function that is appropriate for the task that the informer neural network is configured to perform.

During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the informer neural network in parallel.

Moreover, the system can first pre-train the neural network on a large unsupervised data set through unsupervised learning, e.g., to minimize a BERT loss or other unsupervised loss, and then fine-tune the neural network on task-specific training data to optimize the objective function for the task.

An “embedding,” as used in this specification is a vector of numeric values, e.g., floating point or other type of numeric values, that has a predetermined dimensionality, e.g., has a predetermined number of values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system for performing a task comprising processing a network input to generate a network output, the system comprising one or more computers and one or more storage devices storing instructions that, when executed by the one or more computers, cause the one or more computers to implement:
a neural network configured to perform the task, the neural network comprising a plurality of layers that comprise one or more intention layers, each intention layer configured to receive a layer input for the intention layer and to process the layer input to generate a layer output for the intention layer, each intention layer comprising a set of one or more intention sub-layers, each intention sub-layer configured to perform operations comprising:
obtaining a query matrix, a key matrix, and a value matrix for the intention sub-layer, wherein at least one of the query matrix, the key matrix, and the value matrix are derived from the layer input to the intention layer;
determining a key covariance matrix that estimates a covariance of the key matrix;
determining an inverse matrix that represents an inverse of the key covariance matrix; and
determining a sub-layer output for the intention sub-layer from the inverse matrix, the query matrix, and the value matrix.

2. The system of claim 1, wherein obtaining a query matrix, a key matrix, and a value matrix for the intention sub-layer comprises:
obtaining an initial query matrix for the intention sub-layer; and
applying a first set of one or more learned transformations to the initial query matrix to generate the query matrix.

3. The system of claim 1, wherein obtaining a query matrix, a key matrix, and a value matrix for the intention sub-layer comprises:
obtaining an initial key matrix for the intention sub-layer; and
applying a first set of one or more learned transformations to the initial key matrix to generate the key matrix.

4. The system of claim 1, wherein obtaining a query matrix, a key matrix, and a value matrix for the intention sub-layer comprises:
obtaining an initial value matrix for the intention sub-layer; and
applying a first set of one or more learned transformations to the initial value matrix to generate the value matrix.

5. The system of claim 1, wherein the query matrix, the key matrix, and the value matrix are each derived from the layer input by applying a respective set of one or more learned transformations to the layer input.

6. The system of claim 1, wherein the query matrix is derived from the layer input and the key matrix and the value matrix are each derived from a memory corresponding to the intention sub-layer.

7. The system of claim 1, wherein the plurality of layers further comprise a respective feed-forward layer following each of the one or more intention layers.

8. The system of claim 1, wherein the set of intention sub-layers includes only a single intention sub-layer and wherein the intention layer is configured to generate the layer output from the sub-layer output of the single intention sub-layer.

9. The system of claim 8, wherein generating the layer output from the sub-layer output of the single intention sub-layer comprises applying a residual connection, a normalization layer, or both to the sub-layer output of the single intention sub-layer.

10. The system of claim 1, wherein the set of intention sub-layers includes a plurality of intention sub-layers and wherein the intention layer is configured to:
combine the sub-layer outputs of the plurality of intention sub-layers to generate a combined sub-layer output; and
generate the layer output from the combined sub-layer output.

11. The system of claim 10, wherein generating the layer output from the combined sub-layer output comprises applying a residual connection, a normalization layer, or both to the combined sub-layer output.

12. The system of claim 1, wherein determining a sub-layer output for the intention sub-layer from the inverse matrix, the query matrix, and the value matrix comprises:
determining, from the inverse matrix and the value matrix, a mapping matrix; and
determining the sub-layer output from the mapping matrix and the query matrix.

13. The system of claim 12, wherein, determining, from the inverse matrix and the value matrix, a mapping matrix comprises:
computing a first matrix product between the inverse matrix and a transpose of the key matrix; and
computing a second matrix product between the first matrix product and the value matrix.

14. The system of claim 13, wherein, determining, from the inverse matrix and the value matrix, a mapping matrix comprises:
applying one or more learned transformations to the second matrix product.

15. The system of claim 12, wherein determining the sub-layer output from the mapping matrix and the query matrix comprises:
determining a third matrix product between the query matrix and the mapping matrix.

16. The system of claim 15, wherein the sub-layer output comprises the third matrix product.

17. The system of claim 15, wherein determining the sub-layer output from the mapping matrix and the query matrix comprises:
applying a row-wise softmax function to the mapping matrix prior to computing the third matrix product between the query matrix and the mapping matrix.

18. The system of claim 12, wherein the sub-layer output comprises the mapping matrix.

19. The system of claim 1, wherein determining an inverse matrix that represents an inverse of the key covariance matrix comprises:
computing a pseudo-inverse of the key covariance matrix.

20. The system of claim 1, wherein determining a key covariance matrix that estimates a covariance of the key matrix comprises:
computing a matrix product between a transpose of the key matrix and the key matrix; and
summing the matrix product with a product between a scalar value and an identity matrix.

21. The system of claim 20, wherein the scalar value is a learned parameter of the neural network.

22. The system of claim 1, wherein the task is image classification, the network input represents an image and the output classifies the image into one or more of a set of categories.

23. The system of claim 1, wherein the task is speech recognition, the network input is audio data representing speech and the output is a text transcription of the speech.

24. The system of claim 1, wherein the task is neural machine translation, the network input is a sequence of text in a source language and the output is a sequence of text in a target language that is a translation of the network input.

25. One or more computer storage media storing instructions that when executed by one or more computer cause the one or more computer to implement:
a neural network configured to perform the task, the neural network comprising a plurality of layers that comprise one or more intention layers, each intention layer configured to receive a layer input for the intention layer and to process the layer input to generate a layer output for the intention layer, each intention layer comprising a set of one or more intention sub-layers, each intention sub-layer configured to perform operations comprising:
obtaining a query matrix, a key matrix, and a value matrix for the intention sub-layer, wherein at least one of the query matrix, the key matrix, and the value matrix are derived from the layer input to the intention layer;
determining a key covariance matrix that estimates a covariance of the key matrix;
determining an inverse matrix that represents an inverse of the key covariance matrix; and
determining a sub-layer output for the intention sub-layer from the inverse matrix, the query matrix, and the value matrix.

26. A method comprising:
receiving a network input; and
processing the network input using a neural network to generate a network output for the network input, the neural network comprising a plurality of layers that comprise one or more intention layers, each intention layer configured to receive a layer input for the intention layer and to process the layer input to generate a layer output for the intention layer, each intention layer comprising a set of one or more intention sub-layers, each intention sub-layer configured to perform operations comprising:
obtaining a query matrix, a key matrix, and a value matrix for the intention sub-layer, wherein at least one of the query matrix, the key matrix, and the value matrix are derived from the layer input to the intention layer;
determining a key covariance matrix that estimates a covariance of the key matrix;
determining an inverse matrix that represents an inverse of the key covariance matrix; and
determining a sub-layer output for the intention sub-layer from the inverse matrix, the query matrix, and the value matrix.
